(19) United States
(12) Patent Application Publication
(10) Pub. No.: US 2009/0012898 A1
(43) Pub. Date: Jan. 8, 2009

(54) Location based credit card fraud prevention

(75) Inventors: Ranjan Sharma, New Albany, OH (US); Shengqiang Wang, Raleigh, NC (US)

Correspondence Address: FAY SHARPE/LUCENT, 1100 SUPERIOR AVE, SEVENTH FLOOR, CLEVELAND, OH, 44114, US

(73) Assignee: Lucent Technologies Inc.

(21) Appl. No.: 11/822,053

(22) Filed: Jul. 2, 2007

(51) Int. Cl. G06Q 20/00

(52) U.S. Cl. 705/44

(57) ABSTRACT

A method is provided for blocking an unauthorized use of a payment instrument for a transaction. The method includes: establishing a transaction location (30) where the payment instrument is being used for the transaction; determining a location of a mobile station (20) served by a wireless telecommunications network (10); comparing the determined location of the mobile station (20) with the established transaction location (30); and, blocking completion of the transaction when the determined location of the mobile station (20) does not sufficiently match the established transaction location (30).

### FIELD

The present inventive subject matter relates to the wireless telecommunication arts. Particular application is found in conjunction with certain types of mobile telecommunication networks and devices, and the specification makes particular reference thereto. However, it is to be appreciated that aspects of the present inventive subject matter are also amenable to other like networks, devices and/or applications.

### BACKGROUND

Payment instruments, such as credit cards, debits cards, ATM (Automated Teller Machine) cards, and the like are commonly used by account holders to make purchases and/or engage in other transactions at stores, shops, ATMs and/or other like physical locations. Typically, each such instrument or card carries various information associated with the particular card, e.g., an account holder name, a card number, an expiration date, etc. For example, this information may be imprinted on the card, encoded on a magnetic strip, or otherwise contained on the card.

A so called “card present transaction” refers to a transaction in which the card is physically present at the time and place of the transaction. Commonly, in a card present transaction, the card being presented for payment or otherwise used in connection with the transaction is swiped, scanned or otherwise read, e.g., by a point-of-sale (POS) terminal or other like card reader, to obtain the relevant card information, i.e., card number, expiration date, account holder name, etc. Prior to completing the transaction, the obtained card information and a set of corresponding transaction details are forwarded to or otherwise submitted over a transaction processing network for approval, e.g., by the institution that issued the card. Commonly, the transaction details include a transaction amount and an identification of the merchant, seller, ATM, POS terminal or the like that is requesting the approval to complete the transaction. The aforementioned identification is typically accompanied by a street address or other like indicator of the location at which the transaction is being conducted.

While the aforementioned payment instruments or cards generally provide account holders a measure of convenience to conduct various transactions, they are susceptible to fraudulent and/or other types of unauthorized use. For example, an unauthorized user may attempt to make purchases or conduct other transactions with a stolen or otherwise ill-gotten payment instrument or card. To protect against these fraudulent and/or unauthorized uses, various approaches have been previously implemented in an effort to ensure that only the account holder named or otherwise identified on the card is able to use the card. For example, the card may carry the account holder's signature. Accordingly, a signature provided by the user of the card at the time of the transaction can be compared to the signature on the card to verify that the user is in fact the account holder. In another example, the user of the card may be required to supply a PIN (Personal Identification Number) or other secret code before a transaction can be initiated with the card. In yet another example, the user of the card may be required to present some secondary form of ID indicating that they are in fact the account holder named or otherwise identified on the card.

Some degree of security against fraudulent or otherwise unauthorized card use is provided by the foregoing solutions. However, these solutions are limited in various respects. For example, signatures can be forged, PINs can guessed or otherwise become compromised, and false secondary IDs can be created or obtained by unscrupulous individuals.

Accordingly, a new and improved system and/or method for guarding against the unauthorized use of payment instruments or cards is provided that overcomes the above-referenced problems and others.

### SUMMARY

In accordance with one embodiment, a method is provided for blocking an unauthorized use of a payment instrument for a transaction. The method includes: establishing a transaction location where the payment instrument is being used for the transaction; determining a location of a mobile station served by a wireless telecommunications network and carried by the account holder; comparing the determined location of the mobile station with the established transaction location; and, blocking completion of the transaction when the determined location of the mobile station does not sufficiently match the established transaction location.

In accordance with another embodiment, a system is provided for blocking an unauthorized use of a payment instrument for a transaction. The system includes: transaction locating means for establishing a transaction location where the payment instrument is being used; mobile station locating means for determining a location of a mobile station carried by the account holder; comparing means for comparing the location of the mobile station provided by the mobile station locating means with the established transaction location provided by the transaction locating means; and, blocking means for blocking completion of the transaction when the comparing means determines that the location of the mobile station provided by the mobile station locating means does not sufficiently match the established transaction location provided by the transaction locating means.

Numerous advantages and benefits of the inventive subject matter disclosed herein will become apparent to those of ordinary skill in the art upon reading and understanding the present specification.

### BRIEF DESCRIPTION OF THE DRAWINGS

The inventive subject matter may take form in various components and arrangements of components, and in various steps and arrangements of steps. The drawings are only for purposes of illustrating preferred embodiments and are not to be construed as limiting. Further, it is to be appreciated that the drawings are not to scale.

FIG. 1 is a block diagram illustrating an exemplary network configuration suitable for practicing aspects of the present inventive subject matter.

FIG. 2 is a flow chart illustrating an exemplary process suitable for practicing aspects of the present inventive subject matter.

### DETAILED DESCRIPTION OF PREFERRED EMBODIMENTS

For clarity and simplicity, the present specification shall refer to structural and/or functional elements, relevant communication standards, protocols and/or services, and other components that are commonly known in the art without further detailed explanation as to their configuration or operation except to the extent they have been modified or altered in accordance with and/or to accommodate the preferred embodiment(s) presented herein.

The present specification describes a system and/or method for guarding against the unauthorized use of payment instruments, such as, credit cards, debit cards, ATM cards, etc. in connection with various transactions. Generally, the described system and/or method seeks to verify that an account holder (which also subscribes to a wireless telecommunications service) is at or near the location of a transaction where the payment instrument or card is being used at the time.

More specifically, an account holder initially subscribes to a location-based enforcement feature or service. In doing so, the account holder registers a selected payment instrument such that it is linked to a mobile station (MS) (e.g., which may be the account holder's wireless telephone or other wireless end user device). Suitably, for example, the card number of the registered payment instrument is associated with the telephone number of the account holder's MS. Accordingly, when the registered card or other payment instrument of the account holder is being used in a transaction, a location of the transaction is established from the transaction details submitted to or over a transaction processing network. Provided the account holder subscribes to and/or has enabled the location-based enforcement feature, the location of the account holder is then also determined by locating the account holder's MS. That is to say, presuming that the account holder is in possession of their MS (i.e., the MS associated with the registered card or payment instrument during the subscription process), then suitably, the location of the account holder is determined by locating the account holder's MS via the wireless telecommunications network serving the MS. If the established location of the transaction and the determined location of the account holder sufficiently match one another (i.e., within some determined threshold distance or tolerance), then the transaction is approved, otherwise the transaction is denied.

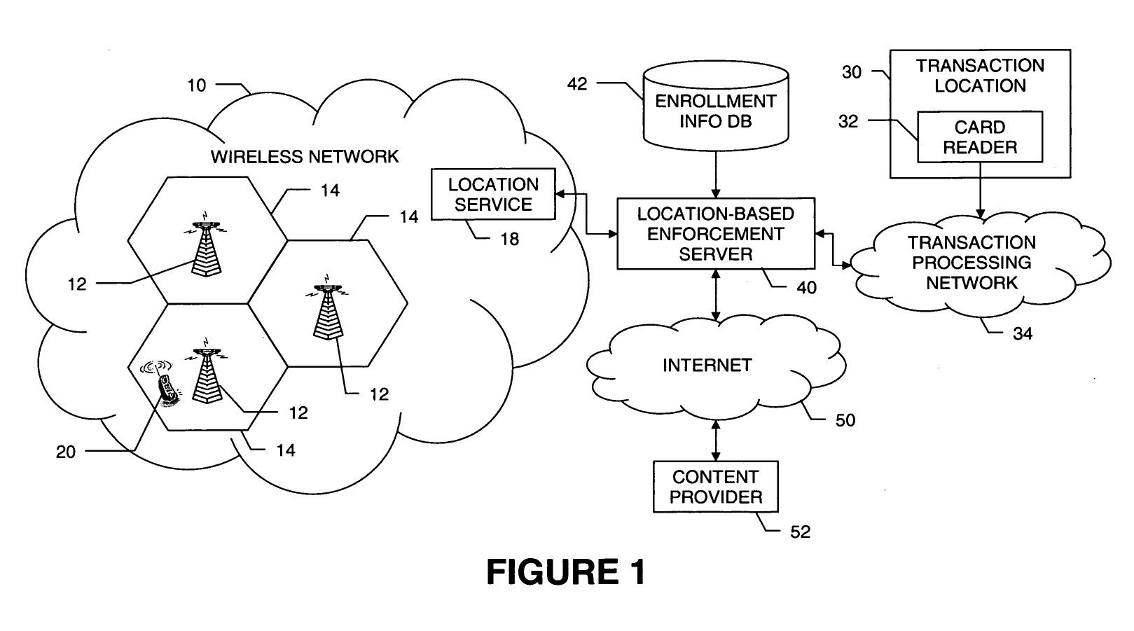

With reference now to FIG. 1, a wireless telecommunications network 10 includes, in the usual manner, a plurality of base stations (BS) 12. As is understood in the art, each BS 12 provides an over-the-air radio frequency interface for a respective geographic area or cell 14. Selectively, a mobile station (MS) 20 of an account holder (e.g., in the form of a mobile telephone or any other suitable wireless end user terminal) is provided telecommunication services and/or otherwise accesses the network 10 via the interface and/or BS 12 serving the cell 14 in which the MS 20 is located. While only three BS 12 and three corresponding cells 14 are illustrated in FIG. 1 for purposes of simplification and clarity, it is to be appreciated that the network 10 in practice includes any number of one or more BS and/or cells that are similarly situated and/or arranged. Additionally, while only one exemplary MS is illustrated in FIG. 1, the network 10 optionally serves any number of one or more mobile stations similarly situated and/or arranged in any of the one or more cells 14.

FIG. 1 also illustrates an exemplary transaction location 30 (e.g., a store, shop, bank or other like physical location) at which a card or other like payment instrument is selectively used to conduct a purchase or other suitable transaction. As shown, the transaction location 30 suitably includes a card reader 32 (e.g., a POS terminal, ATM or other like card reader) in which a card or other payment instrument is inserted or swiped and/or by which a card or other payment instrument is scanned or otherwise read to obtain the relevant card information (i.e., card number, expiration date, account holder name, etc.) in connection with a transaction being conducted. Suitably, the obtained card information and a set of corresponding transaction details are submitted (e.g., by the card reader 32) to a transaction processing network 34 for authorization to complete the transaction. Suitably, the transaction details include a transaction amount and an identification of the merchant, seller, ATM, POS terminal or the like that is requesting the approval to complete the transaction. In the usual manner, the aforementioned identification is accompanied by a street address or other like indicator of the location 30 at which the transaction is being conducted.

In the illustrated embodiment, the location-based enforcement feature is administered by and/or supported on a server 40 or the like which is in operative communication with both the transaction processing network 34 and the wireless telecommunication network 10. Optionally, an account holder may selectively subscribe to the location-based enforcement feature via an online or Internet based enrollment process, whereby the account holder registers a selected payment instrument or card such that it is linked to their MS (e.g., the MS 20). For example, during the enrollment process, the account holder enters and/or otherwise identifies one or more particular payment instruments that are to be associated with and/or linked to one or more particular mobile stations. Suitably, each registered payment instrument is identified by the appropriate card or account number or some other like identifier and each corresponding MS is identified by its respective telephone number or MSIN (Mobile Station Identification Number). As illustrated, the registration and/or enrollment information is optionally maintained in a database (DB) 42 that is accessible by the server 40. Suitably, the DB 42 relates each card or account number therein with one or more corresponding MS telephone numbers or MSINs.

During the subscription and/or enrollment process, the account holder is also optionally able to set or select a desired threshold distance and/or tolerance (i.e., a “safety margin”) which is likewise maintained in the DB 42 along with the account holder's other registration/enrollment information. Additionally, from time-to-time, the account holder may selectively update and/or change their registration and/or enrollment information as they see fit. Moreover, form time-to-time, the account holder may selectively activate and/or deactivate the location-based enforcement feature as they see fit. Suitably, the DB 42 uses a flag or other like indicator to reflect which card or account numbers listed therein have the feature activated and/or which have the feature deactivated.

Table 1 shows an exemplary format of the DB 42.

TABLE 1

| Account | | | | |
|---|---|---|---|---|
| Holder | Payment | Telephone | Safety | |
| Name | Instrument ID | No./MSIN | Margin | Status |
| John Doe | 1111 2222 3333 4444 | 216.555.1234 | 50 ft | active |
| John Doe | 1212 3333 4444 5555 | 216.555.1234 | 50 ft | active |
| Jane Doe | 2222 3434 5555 6666 | 216.555.6789 | 100 ft | active |
| Jane Doe | 1212 3434 5656 7777 | 216.555.6789 | 75 ft | inactive |
| Jane Doe | 7777 8888 9999 1234 | 216.555.9876 | 500 ft | active |
| Joe Smith | 1234 5678 9999 1234 | 216.555.4321 | 150 ft | active |

As can be appreciated from the exemplary Table 1, a given account holder may in some cases have multiple payment instruments and/or a plurality of different mobile stations. Therefore, they may optionally choose to register one or more selected payment instruments with one particular MS, while registering one or more other payment instruments with another particular MS. For example, with reference to the exemplary Table 1, Jane Doe's first two payment instruments could be personal credit cards that are registered or associated with her personal cell phone (which she normally carries together), while the third payment instrument could be a business credit card that is registered or associated with her business cell phone (which she only carries on official business).

Suitably, the server 40 (and/or the location-based enforcement feature administer thereby and/or supported thereon) is operative to selectively obtain the location of a designated MS from the wireless telecommunications network 10. For example, the location of the MS 20 is obtained by the server 40 and/or the feature supported thereon from a location service 18 that operates in the usual manner to monitor and/or find the location of the MS 20 within the wireless network 10. Suitably, the server 40 and/or the feature supported thereon supply the location service 18 with a telephone number or MSIN of the MS being sought. In response, the location service 18 resolves or otherwise obtains the location of the corresponding MS and returns the location information to the server 40 and/or the feature supported thereon.

Suitably, the location of the MS 20 is determined in accordance with and/or by any one or more known methods and/or approaches. That is to say, in practice, the location service 18 uses any one or more of various known techniques to measure or detect the current location of the MS 20, e.g., as identified by its telephone number of MSIN. For example, the MS 20 is optionally equipped with a global positioning system (GPS) receiver or other like device from which the location of the MS 20 is obtained by the location service 18 and returned to the server 40 upon request. Alternately, a network or MS-based technique is employed by the location service 18 to determine or measure the location of the MS 20, e.g., using the over-the-air interfaces and/or signals exchanged between the MS 20 and one or more of the BS 30. For example, suitable known network and/or MS-based solutions for determining the location of the MS 20 include, without limitation: observed time difference (OTD); time of arrival (TOA); time difference of arrival (TDOA); angle of arrival (AOA); multipath fingerprinting; timing advance (TA); enhanced forward link triangulation (E-FLT); received signal strength (RSS); etc. Optionally, a hybrid location determination solution combining one or more of the aforementioned techniques is employed or so-called assisted-GPS may also be employed.

Additionally, the server 40 (and/or the location-based enforcement feature administer thereby and/or supported thereon) is also operative to monitor the transaction processing network 34 and/or otherwise obtain payment instrument and/or card information and the corresponding transaction details that are submitted (e.g., by the card reader 32) to the transaction processing network 34 for authorization. Optionally, from the obtained payment instrument and/or card information, the payment instrument ID or card number is extracted and compared to the DB 42 to find a matching payment instrument ID or card number. If a matching record is found and optionally if the status is indicated as active, then the feature is implemented for the particular transaction.

When the location-based enforcement feature is implemented, the location of the transaction is established from the obtained transaction details. Additionally, the telephone number or MSIN from the matching record in the DB 42 is provided to the location service 18 of the wireless network 10, which in turn returns the location of the MS having the provided telephone number or MSIN. Suitably, the location of the MS is returned as latitude and longitude coordinates, however, the location identified in the transaction details is generally provided in the form of a street address. Accordingly, to facilitate comparison, the street address of the transaction location is optionally resolved into latitude and longitude coordinates, e.g., that are returned in response to submitting the street address location (e.g., over the Internet 50) to a content provider 52 or other like entity or service for translation and/or geo-encoding. The established transaction location (e.g., location 30) and the determined location of the sought MS (e.g., MS 20) are then compared to determine if they are sufficiently close to one another, i.e., if they are within the safety margin designated in the matching record of the DB 42. That is to say, suitably, the distance between the transaction location and the MS location is calculated and if the distance between the two locations is within the designated safety margin, then the two locations are deemed sufficiently close to one another, otherwise if the distance between the two locations is outside the designated safety margin, then the two locations are not considered sufficiently close to one another. Ultimately, if the two locations are sufficiently close to one another, then the transaction is approved and/or allowed to be completed, otherwise if the two locations are not sufficiently close to one another, then the transaction is denied or blocked from being completed. In this manner, if a registered payment instrument or card of an account holder is stolen or otherwise misappropriated, the unauthorized user will not be able to complete a transaction with the payment instrument or card in the absence of the account holder insomuch as the physical separation of the payment instrument or card from the MS of the account holder (which is presumably still in the possession of the account holder) will thwart approval of the transaction. Conversely, when the account holder attempts to use their registered payment instrument or card to conduct a transaction at a particular location, they are permitted to do so insomuch as the account holder's proximity to the location of the transaction is verified by locating of the account holder's MS (which is presumably in their possession).

Of course, in some instances, the wireless network 10 may be unable to locate the MS 20. For example, the MS 20 may be out of the service area or powered off due to particular regulations (e.g., while in a hospital) or for any other reason. In such cases, suitably, the location-based enforcement feature simply defaults to denying any transaction which would otherwise rely on locating the MS 20. Additionally, for online or Internet based transaction, the location of the transaction or online merchant may appear to be different from where the user is accessing the Internet, and accordingly, the transaction may be denied by the location-based enforcement feature. In these situations, the account holder has the flexibility of selectively deactivating the feature when they know such circumstances will exist, and then optionally reactivating the feature when those circumstances cease to exist. Suitably, the deactivation and/or reactivation is achieved by accessing an appropriate activation function, e.g., over the Internet via a computer or via a data network service available on the MS 20.

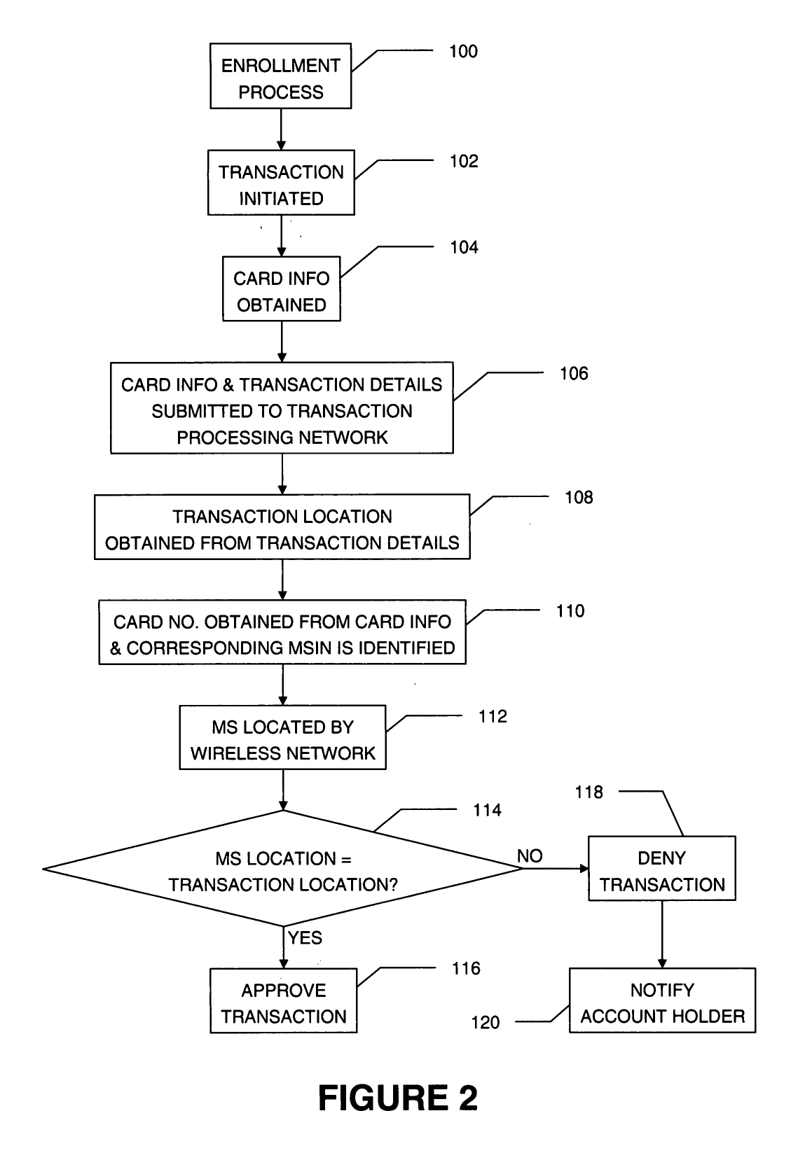

With reference to FIG. 2, an exemplary process for implementing the location-based enforcement feature is now described.

At step 100, an account holder subscribes to the feature and/or otherwise enrolls a selected payment instrument or card. As described above, optionally, an account holder may selectively subscribe to the location-based enforcement feature via an online or Internet based enrollment process, whereby the account holder registers a selected payment instrument or card such that it is linked to their MS (e.g., the MS 20).

At step 102, a transaction is initiated with a payment instrument or card, e.g., at transaction location 30.

At step 104, the payment instrument or card information is obtained, e.g., by the card reader 32.

At step 106, the obtained card information and corresponding transaction details are submitted, e.g., by the card reader 32, to the transaction processing network 34 for authorization to complete the transaction.

At step 108, the location of the transaction (e.g., the location 30) is established from the transaction details submitted to the transaction processing network 34.

At step 110, the payment instrument ID or card number is obtained from the card information submitted to the transaction processing network 34 and the corresponding telephone number or MSIN of the MS 20 is identified, e.g., by accessing the DB 42 with the obtained payment instrument ID.

At step 112, the MS 20 having the telephone number or MSIN identified in step 110 is located via the wireless network 10.

At decision step 114, it Is determined if the MS location is substantially equal to the transaction location (i.e., if the MS location and transaction location are within a sufficiently close distance to one another or within the designated safety margin). If the MS location is substantially equal to or sufficiently close to the transaction location, then the process continues to step 116 and the transaction is approved or allowed to be completed. Otherwise, if the MS location is not substantially equal to or not sufficiently close to the transaction location, then the process branches to step 118 and the transaction is denied or barred from being completed.

In one suitable embodiment, if the transaction is denied or barred from being completed, then at step 120, the account holder is optionally informed of the failed transaction attempt. For example, an SMS (Short Message Service) message is optionally send to the MS 20 indicating that the transaction has been denied. Alternately or in addition, an e-mail message may also be sent to the account holder at a designated address (e.g., which may be included in the DB 42). In any event, suitably, the message indicates the card information and/or transaction details which were associated with the failed transaction. Accordingly, the account holder would be informed of any fraudulent activity with respect to their card. Alternately, if the account holder was in fact using the card for the transaction in question, they are accordingly prompted to adjust their location or reset the safety margin or deactivate the feature so as to allow the transaction to complete on a subsequent attempt.

It is to be appreciated that in connection with the particular exemplary embodiments presented herein certain structural and/or function features are described as being incorporated in defined elements and/or components. However, it is contemplated that these features may, to the same or similar benefit, also likewise be incorporated in other elements and/or components where appropriate. It is also to be appreciated that different aspects of the exemplary embodiments may be selectively employed as appropriate to achieve other alternate embodiments suited for desired applications, the other alternate embodiments thereby realizing the respective advantages of the aspects incorporated therein.

It is also to be appreciated that particular elements or components described herein may have their functionality suitably implemented via hardware, software, firmware or a combination thereof. Additionally, it is to be appreciated that certain elements described herein as incorporated together may under suitable circumstances be stand-alone elements or otherwise divided. Similarly, a plurality of particular functions described as being carried out by one particular element may be carried out by a plurality of distinct elements acting independently to carry out individual functions, or certain individual functions may be split-up and carried out by a plurality of distinct elements acting in concert. Alternately, some elements or components otherwise described and/or shown herein as distinct from one another may be physically or functionally combined where appropriate.

In short, the present specification has been set forth with reference to preferred embodiments. Obviously, modifications and alterations will occur to others upon reading and understanding the present specification. It is intended that the invention be construed as including all such modifications and alterations insofar as they come within the scope of the appended claims or the equivalents thereof.

What is claimed is:

1. A method of blocking an unauthorized use of a payment instrument for a transaction, said method comprising:
(a) establishing a transaction location where the payment instrument is being used for the transaction;
(b) determining a location of a mobile station served by a wireless telecommunications network;
(c) comparing the determined location of the mobile station with the established transaction location; and,
(d) blocking completion of the transaction when the determined location of the mobile station does not sufficiently match the established transaction location.

2. The method of claim 1, wherein the payment instrument is selected from a group consisting of a credit card, a debit card and an ATM card.

3. The method of claim 1, wherein step (c) comprises:
calculating a distance between the determined location of the mobile station and the established transaction location.

4. The method of claim 3, wherein the determined location of the mobile station is deemed to not sufficiently match the established transaction location if the calculated distance therebetween exceeds a designated threshold distance.

5. The method of claim 1, said method further comprising, prior to the payment instrument being used for the transaction:
registering the payment instrument such that it is linked to the mobile station.

6. The method of claim 5, wherein said registering further comprises:
storing a payment instrument ID for the payment instrument; and,
associating the stored payment instrument ID with a mobile station identifier assigned to the mobile station.

7. The method of claim 6, wherein the mobile station identifier is one of a telephone number or a mobile station identification number assigned to the mobile station.

8. The method of claim 6, said method further comprising, at the time the payment instrument is being used for the transaction:
obtaining from the payment instrument payment instrument information, said payment instrument information including the payment instrument ID for the payment instrument;
establishing transaction details for the transaction in which the payment instrument is being used, said transaction details indicating the location at which the transaction is being conducted; and,
submitting the payment instrument information along with the corresponding transaction details to a transaction processing network for authorization of the transaction.

9. The method of claim 8, wherein the transaction location established in step (a) is obtained from the transaction details submitted to the transaction processing network.

10. The method of claim 9, said method further comprising:
extracting the payment instrument ID from the payment information submitted to the transaction processing network;
selecting the mobile station identifier associated with stored payment instrument ID that matches the extracted payment instrument ID; and,
providing the selected mobile station identifier to the wireless telecommunications network.

11. The method of claim 10, wherein step (b) comprises:
the wireless telecommunications network obtaining the location of the mobile station to which the provided mobile station identifier is assigned.

12. A system for blocking an unauthorized use of a payment instrument for a transaction, said system comprising:
transaction locating means for establishing a transaction location where the payment instrument is being used;
mobile station locating means for determining a location of a mobile station;
comparing means for comparing the location of the mobile station provided by the mobile station locating means with the established transaction location provided by the transaction locating means; and,
blocking means for blocking completion of the transaction when the comparing means determines that the location of the mobile station provided by the mobile station locating means does not sufficiently match the established transaction location provided by the transaction locating means.

13. The system of claim 12, wherein the payment instrument is selected from a group consisting of a credit card, a debit card and an ATM card.

14. The system of claim 12, wherein comparing means calculates a distance between the determined location of the mobile station provided by the mobile station locating means and the established transaction location provided by the transaction locating means.

15. The system of claim 14, wherein the comparing means determines that location of the mobile station provided by the mobile station locating means does not sufficiently match the established transaction location provided by the transaction locating means if the calculated distance therebetween exceeds a designated threshold distance.

16. The system of claim 12, wherein the mobile station locating means comprises:
a wireless telecommunications network serving the mobile station.

17. The system of claim 12, wherein the system may be selectively activated and deactivated for the payment instrument.
